(19) United States
(12) Patent Application Publication
(10) Pub. No.: US 2012/0013312 A1
(43) Pub. Date: Jan. 19, 2012

(54) Power Control Device and Method thereof

(76) Inventor: Chih-Yuan Hsieh, Hsinchu County (TW)

(21) Appl. No.: 13/174,738

(22) Filed: Jun. 30, 2011

(30) Foreign Application Priority Data
Jul. 15, 2010 (TW) 099123278

(51) Int. Cl. G05F 1/46

(52) U.S. Cl. 323/234

(57) ABSTRACT

A power control device for tracking a maximum power point (MPP) of a power generator comprises a sensing unit for generating a sensed voltage value and a sensed power value according to a cross voltage and an output current of the power generator; a sample and hold unit for sampling and holding the sensed voltage value and the sensed power value; a comparison and determination unit for generating a determination result according to the sensed voltage value and the sensed power value of a previous time point outputted by the sample and hold unit and the sensed voltage value and the sensed power value of a current time point outputted by the sensing unit; and a voltage converter for adjusting the cross voltage of the power generator to make the power generator reach to the maximum power point according to the determination result.

### BACKGROUND OF THE INVENTION

1. Field of the Invention

The present invention relates to a power control device and method, and more particularly to a power control device and method for realizing a maximum power point tracking by analog circuits.

2. Description of the Prior Art

Cross voltages and power of a power generator, such as a photovoltaic (solar energy) panel or a wind power module, exists a characteristic curve. Each characteristic curve has a maximum power point and varies substantially under different parameters. Therefore, the power generation system should change the cross voltage of the power generator to keep high power generating efficiency at any time.

Please refer FIG. 1, which illustrates a characteristic curve of a photovoltaic panel. The Y axis is the power P of the photovoltaic panel and the X axis is the cross voltage Vp of the photovoltaic panel. As shown in FIG. 1, the power P has a maximum power point versus the cross voltage Vp. Because the characteristic curve varies substantially with different sun-exposing time and temperature, the power generating system needs a power control device with a maximum power point tracking (MPPT) function to track the cross voltage Vp corresponding to a maximum power point MPP, so as to keep the photovoltaic panel in the highest power generating efficiency at any time.

Conventionally, the maximum power point tracking function is realized by a digital signal processor (DSP). However, because the input and output signals of the power control device both are analog signals, the input signal needs to be converted by an analog-to-digit (A/D) converter before entering into the DSP; and the output signal also needs to be converted by a digital-to-analog (D/A) converter when outputted from the DSP. In addition, the DSP further needs a phase lock loop (PLL) circuit to perform signal synchronization.

Please refer FIG. 2, which illustrates a schematic diagram of a prior art MPPT device 20 realized by the DSP technique. The MPPT device 20 includes A/D converters 21 and 22, a DSP 23, a PLL circuit 24 and a D/A converter 25. As shown in FIG. 2, the MPPT device 20 converts a voltage signal V and a current signal I of the power generator to digital signals through the A/D converters 21 and 22. Afterwards, the D/A converter 25 output an analog control signal after the DSP 23 performs an internal operation on the digital signals. Therefore, a voltage converter (not shown) of the power generating system can change the cross voltage of the power generator to reach the maximum power point.

However, realizing the MPPT device by the digital method may cause much cost and more power consumption, while there is also resolution problem limited by the A/D converter and the D/A converter. In addition, the user cannot buy the MPPT device as a single device and increases the difficulty to realize the system.

### SUMMARY OF THE INVENTION

It is therefore an objective of the present invention to provide a power control device and method for realizing a maximum power point tracking by analog circuits.

A power control device for tracking a maximum power point (MPP) of a power generator is disclosed. The power control device includes a sensing unit, a sample and hold unit, a comparison and determination unit and a voltage converter. The sensing unit is coupled to the power generator, and is utilized for generating a sensed voltage value and a sensed power value according to a cross voltage and an output current of the power generator. The sample and hold unit is coupled to the sensing unit, and is utilized for sampling and holding the sensed voltage value and the sensed power value. The comparison and determination unit is coupled to the sample and hold unit and the sensing unit, and is utilized for generating a determination result according to the sensed voltage value and the sensed power value of a previous time point outputted by the sample and hold unit and the sensed voltage value and the sensed power value of a current time point outputted by the sensing unit. The voltage converter is coupled to the comparison and determination unit and the power generator, and is utilized for adjusting the cross voltage of the power generator to make the power generator reach to the maximum power point according to the determination result.

A power control method for tracking a maximum power point (MPP) of a power generator is disclosed. The power control method includes steps of sensing a cross voltage and an output current of the power generator to generate a sensed voltage value and a sensed power value; sampling and holding the sensed voltage value and the sensed power value; generating a determination result according to the sensed voltage value and the sensed power value sampled at a previous time point and the sensed voltage value and the sensed power value sensed at a current time point; and adjusting the cross voltage of the power generator to make the power generator reach to the maximum power point according to the determination result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a characteristic curve of a photovoltaic panel according to an embodiment of the present invention.

FIG. 2 is a block diagram of a prior art maximum power point tracking device realized by a digital signal processing technique.

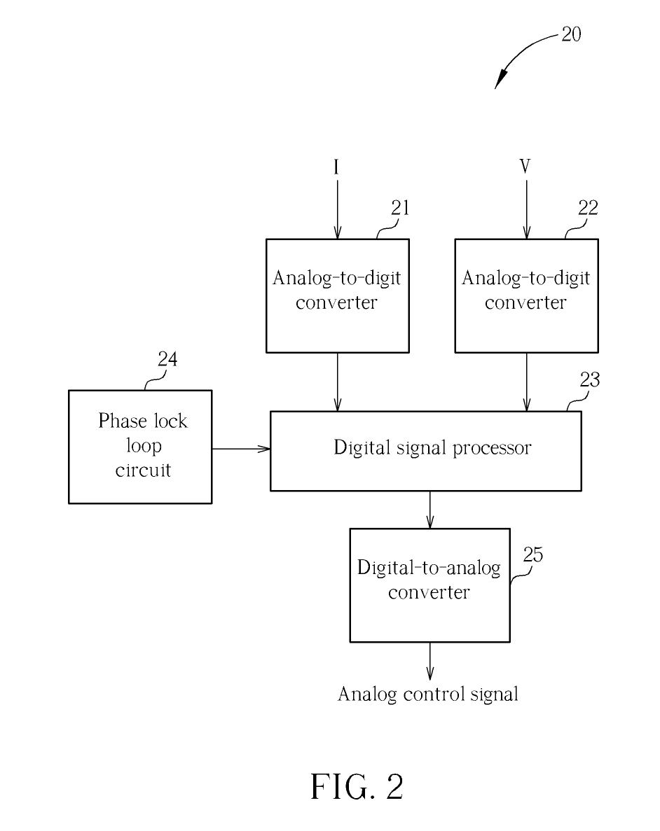

FIG. 3 is a diagram of a power control device according to an embodiment of the present invention.

FIG. 4 is a diagram of a power control device according to an embodiment of the present invention.

FIG. 5 is a flowchart of a determining process of the determination unit shown in FIG. 4.

FIG. 6 is a diagram of a power control process according to an embodiment of the present invention.

### DETAILED DESCRIPTION

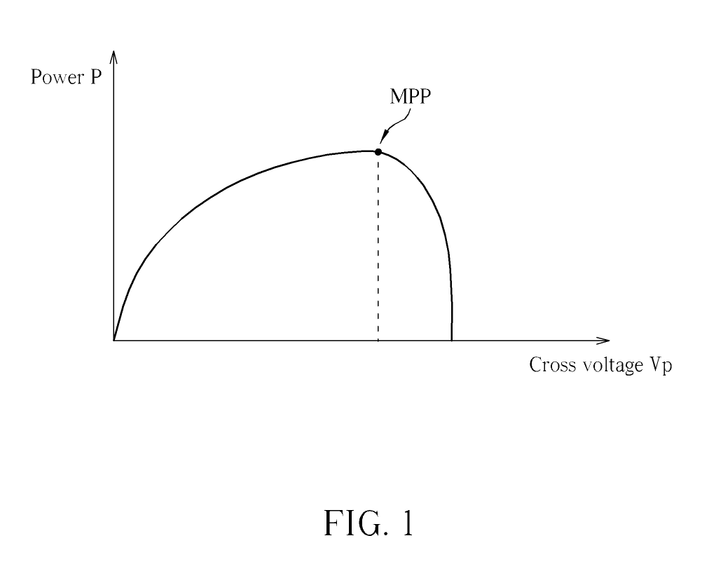

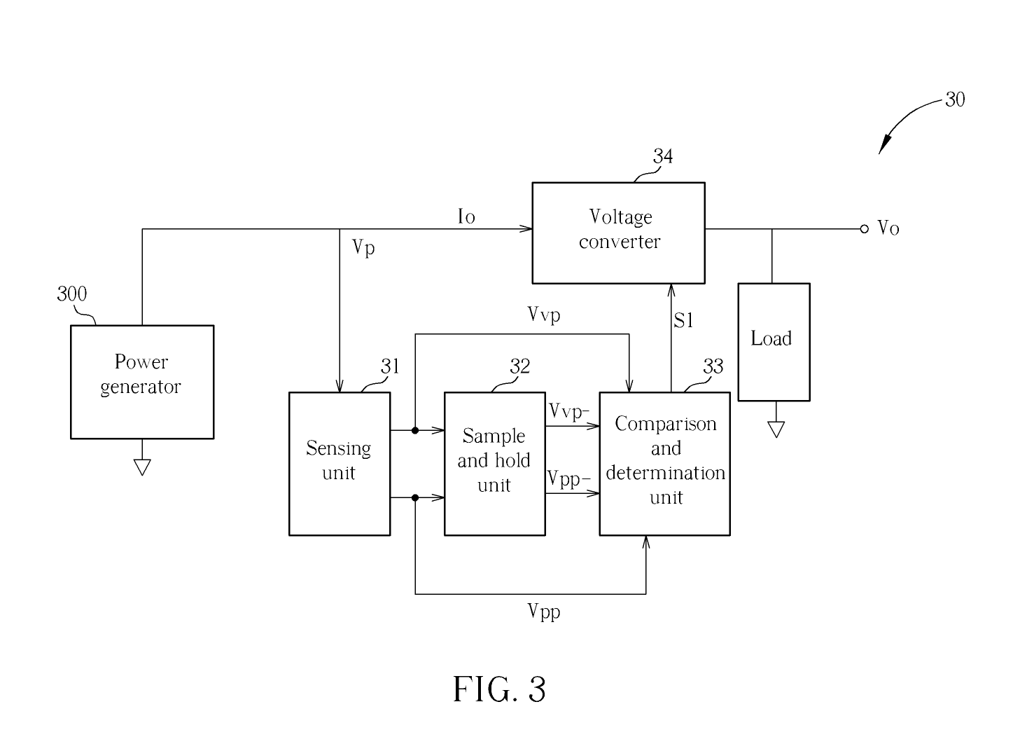

Please refer to FIG. 3, which illustrates a schematic diagram of a power control device 30 according to an embodiment of the present invention. The power control device 30 is utilized for tracking a maximum power point (MPP) of a power generator 300. The power generator 300 can be a photovoltaic panel or a wind power module. Characteristic curves of the power generator 300 exists a maximum power point and varies substantially under different parameters as shown in FIG. 1. The power control device 30 includes a sensing unit 31, a sample and hold unit 32, a comparison and determination unit 33 and a voltage converter 34. The sensing unit 31 is coupled to the power generator 300, and is utilized for generating a sensed voltage value Vvp and a sensed power value Vpp according to a cross voltage Vp and an output current Io of the power generator. The sample and hold unit 32 is coupled to the sensing unit 31, and is utilized for sampling and holding the sensed voltage value Vvp and the sensed power value Vpp. The comparison and determination unit 33 is coupled to the sample and hold unit 32 and the sensing unit 31, and is utilized for generating a determination result S1 according to the sensed voltage value Vvp− and the sensed power value Vpp− of a previous time point outputted by the sample and hold unit 32 and the sensed voltage value Vvp and the sensed power value Vpp of a current time point outputted by the sensing unit 31. The voltage converter 34 is coupled to the comparison and determination unit 33 and the power generator 31, and is utilized for adjusting the cross voltage Vp of the power generator 31 to make the power generator 31 reach to the maximum power point according to the determination result S1.

Therefore, the power control device 30 compares the sensed voltage value Vvp and the sensed power value Vpp of the current time point with the voltage value Vvp− and the power value Vpp− sampled at the previous time point to determine whether to raise or decrease the cross voltage Vp of the power generator 300, so as to reach the goal of the maximum power point tracking. Consequently, the present invention can realize the maximum power point tracking by analog circuits to improve the disadvantage in the prior art. As for details of the power control device 30, please refer to the following description.

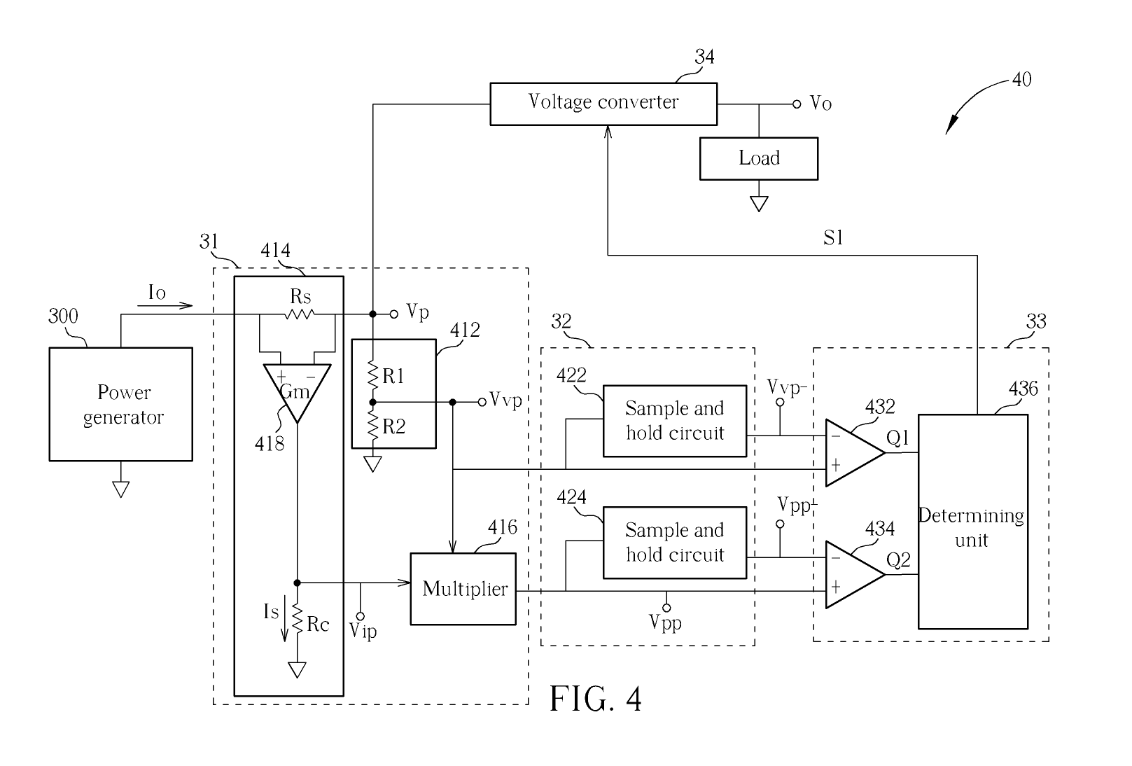

Please refer to FIG. 4, which illustrates a schematic diagram of a power control device 40 according to an embodiment of the present invention. The power control device 40 is a practical circuit of the power control device 30 in FIG. 3, and thus, the same symbols are used to represent the corresponding components of FIG. 3. Those skilled in the art can certainly make alternations and modifications for the power control device 40, however, which should not be construed as a limitation of the invention. In the power control device 40, the sensing unit 31 further includes a voltage sensing circuit 412, a current sensing circuit 414 and a multiplier 416. The voltage sensing circuit 412 is coupled to the power generator 300, and is utilized for sensing the cross voltage Vp of the power generator 300 to generate a sensed voltage value Vvp. The current sensing circuit 414 is coupled to the power generator 300 and realized by a voltage division circuit composed of resisters R1 and R2, for sensing the output current Io to generate a sensed current value Vip. The multiplier 416 is coupled to the voltage sensing circuit 412 and the current sensing circuit 414, and is utilized for performing a multiplication operation on the sensed voltage value Vvp and sensed current value Vip to generate the sensed power value Vpp.

As shown in FIG. 4, the current sensing circuit 414 further includes a sensing resistor Rs, a transconductance amplifier 418 and a current-to-voltage converter Rc. The sensing resistor Rs is coupled in series to the power generator 300 for sensing the output current Io of the power generator 300. The transconductance amplifier 418 has a positive terminal and a negative terminal, coupled to two ends of the sensing resistor Rs, respectively, for performing a transconductance amplification operation on a voltage difference between the two ends of the sensing resistor Rs to generate a sensed circuit Is. The current-to-voltage converter Rc is coupled to the transconductance amplifier 418, for performing a current-to-voltage conversion operation on the sensed current Is to generate the sensed current value Vip.

The sample and hold unit 32 includes sample and hold circuits 422 and 424, which performs sampling and holding operation on the sensed voltage value Vvp and the sensed power value Vpp, respectively. Therefore, the comparison and determination unit 33 can generate a determination result S1 according to the sensed voltage value Vvp− and the sensed power value Vpp− of a previous time point outputted by the sample and hold unit 32 and the sensed voltage value Vvp and the sensed power value Vpp of a current time point outputted by the sensing unit 31.

As shown in FIG. 4, the comparison and determination unit 33 further includes comparators 432 and 434, and a determining unit 436. The comparator 432 is coupled to the sample and hold circuit 422 and the voltage sensing circuit 412, for generating a first comparing result Q1 according to the sensed voltage value Vvp− of the previous time point outputted by the sample and hold circuit 422 and the sensed voltage value Vpp of the current time point outputted by the voltage sensing circuit 412. The comparator 434 is coupled to the sample and hold circuit 424 and the multiplier 416, for generating a second comparing result Q2 according to the sensed power value Vpp− of the previous time point outputted by the sample and hold circuit 424 and the sensed power value Vpp of the current time point outputted by the multiplier 416. The determining unit 436 is coupled to the comparators 432 and 434, for generating the determination result S1 according to the first comparing result Q1 and the second comparing result Q2.

Therefore, the voltage converter 34 can adjust the cross voltage Vp of the power generator 300 according to the determination result S1, to make the power generator 300 approach to the maximum power point. Assuming that the power control device 40 is used for a direct current (DC) power supply system, the voltage converter 34 is then a DC-to-DC converter for performing a DC-to-DC voltage converting operation on the cross voltage Vp to generate a source voltage Vo to the backend load. Generally, the DC-to-DC converter adjusts the voltage level of the input or output voltage via a pulse width modulation (PWM) operation. For example, the voltage converter 34 may adjust duty cycles of internal switches according to the determination result S1, to control charging time that the output current Io of the power generator 300 charges internal capacitor or inductance, so as to change the voltage level of the input voltage (i.e. the cross voltage Vp). Related operation is well-known by those skilled in the art, so detailed description is omitted herein.

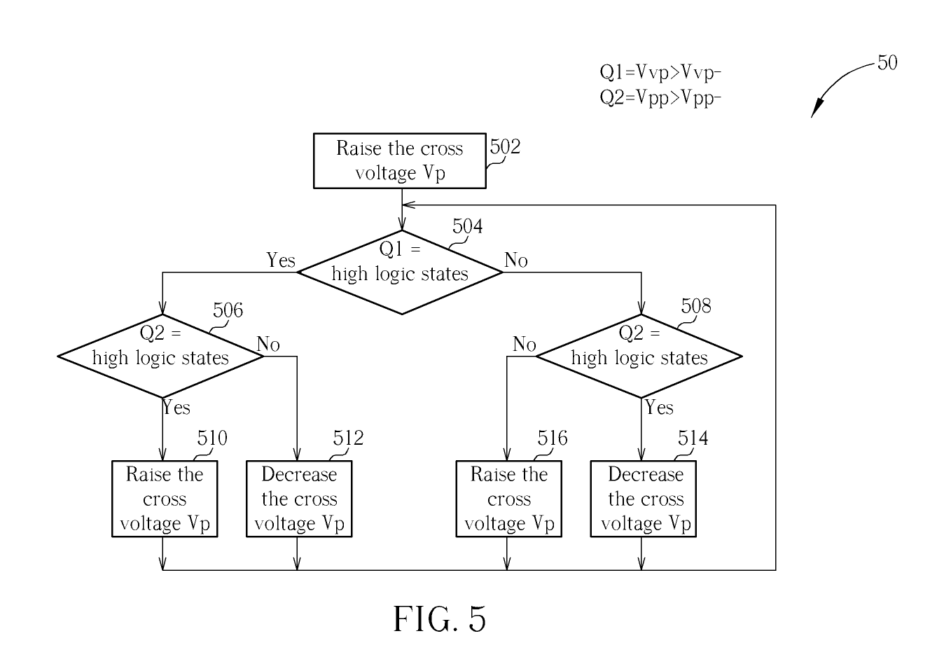

Please refer to FIG. 5, which illustrates a flowchart of a determining process 50 of the determining unit 436 in FIG. 4 according to an embodiment of the present invention. First, the determining unit 436 outputs an initial value of the determination result S1 to control the voltage converter 34 to raise the cross voltage Vp of the power generator 300 (Step 502). Of course, in other embodiments, the initial condition also can be designed to lower the cross voltage Vp of the power generator 300, however, which should not be construed as limitation of the present invention. Afterwards, the determining unit 436 determines the logic status of the first comparing result Q1 and the second comparing result Q2 (Steps 504 to 508). If the sensed voltage value Vvp of the current time point is greater than the sensed voltage value Vvp− of the previous time point and the sensed power value Vpp of the current time point is also greater than the sensed power value Vpp− of the previous time point, the first comparing result Q1 and the second comparing result Q2 are both at high logic states, which represents the previous operation for raising the cross voltage Vp increases the power of the power generator 300. In this situation, the determining unit 436 determines that the current power point is located at the left side of the maximum power point MPP of FIG. 1 and should generate the determination result S1 for raising the cross voltage Vp (Step 510).

If the sensed voltage value Vvp of the current time point is greater than the sensed voltage value Vvp− of the previous time point and the sensed power value Vpp of the current time point is smaller than the sensed power value Vpp− of the previous time point, then the first comparing result Q1 is at high logic state and the second comparing result Q2 is at the low logic state, which represents the previous operation for raising the cross voltage Vp decreases the power of the power generator 300. In this situation, the determining unit 436 determines that the current power point is located at the right side of the maximum power point MPP shown in FIG. 1, and should generate the determination result S1 for decreasing the cross voltage Vp (Step 512).

If the sensed voltage value Vvp of the current time point is smaller than the sensed voltage value Vvp− at the previous time point and the sensed power value Vpp of the current time point is greater than the sensed power value Vpp− of the previous time point, the first comparing result Q1 is then at the low logic state and the second comparing result Q2 is at the high logic state, which represents the previous operation for decreasing the cross voltage Vp increases the power of the power generator 300. In this situation, the determining unit 436 determines that the current power point is located at the right side of the maximum power point MPP shown in FIG. 1, and should generate the determination result S1 for decreasing the cross voltage Vp (Step 514).

If the sensed voltage value Vvp of the current time point is smaller than the sensed voltage value Vvp− of the previous time point and the sensed power value Vpp at the current time point is also smaller than the sensed power value Vpp− of the previous time point, the first comparing result Q1 and the second comparing result Q2 are both at the low logic state, which represents the previous operation for decreasing the cross voltage Vp decreases the power of the power generator 300. In this situation, the determining unit 436 determines that the current power point is located at the left side of the maximum power point MPP shown in FIG. 1, and should generate the determination result S1 for raising the cross voltage Vp (Step 516).

Therefore, by iterating the determining process 50, the power control device 40 can raise or decrease the cross voltage Vp of the power generator 300 according to the determination result S1, such that the power of the power generator can be locked around the maximum power point, thereby achieving the maximum power tracking.

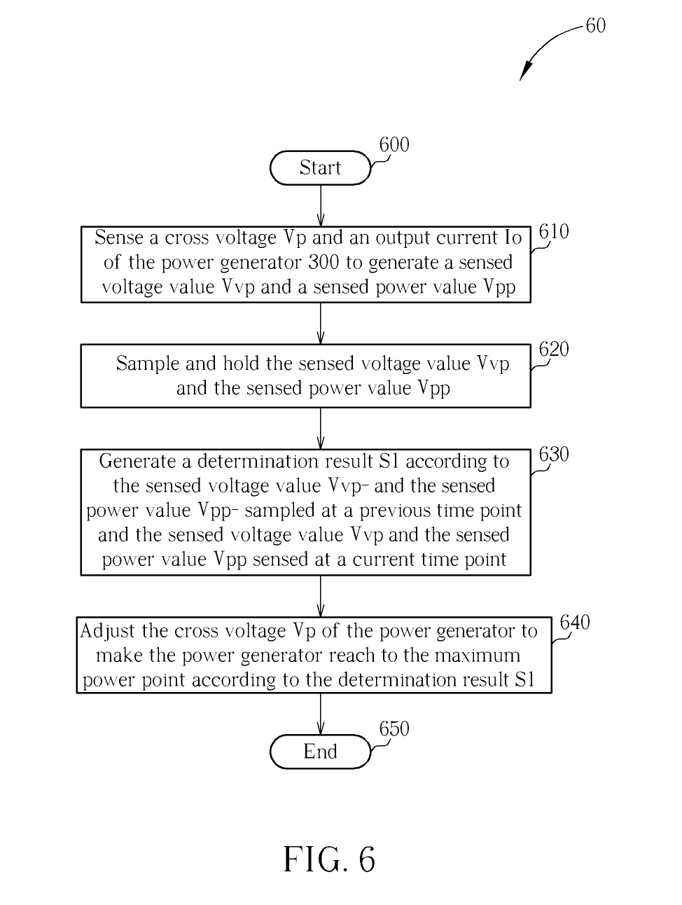

Please refer to FIG. 6, which illustrates a flowchart of a power control process 60 according to an embodiment of the present invention. The power control process 60 is an operation process of the power control devices 30 and 40, and includes the following steps:

Step 600: Start.

Step 610: Sense a cross voltage Vp and an output current Io of the power generator 300 to generate a sensed voltage value Vvp and a sensed power value Vpp.

Step 620: Sample and hold the sensed voltage value Vvp and the sensed power value Vpp.

Step 630: Generate a determination result S1 according to the sensed voltage value Vvp− and the sensed power value Vpp− sampled at a previous time point and the sensed voltage value Vvp and the sensed power value Vpp sensed at a current time point.

Step 640: Adjust the cross voltage Vp of the power generator to make the power generator reach to the maximum power point according to the determination result S1.

Step 650: End.

According to the power control process 60, the present invention compares the sensed voltage value Vvp and the sensed power value Vpp of the current time point with the sensed voltage value Vvp− and the sensed power value Vpp− of the previous time point to determine whether to raise or decrease the cross voltage Vp of the power generator 300, so that the goal of the maximum power point tracking can be reached. The detailed operation of the power control devices 30 and 40 is described on the above, and thus is omitted herein.

In conclusion, the present invention provides an analog maximum power point tracking method to improve the disadvantage of the prior circuit that is realized by a digital signal processor. Besides, the method should not be restricted to the photovoltaic power system, but also can be used in other power generation system such as the wind power system, for example, for tracking the maximum power point.

Those skilled in the art will readily observe that numerous modifications and alterations of the device and method may be made while retaining the teachings of the invention.

What is claimed is:

1. A power control device for tracking a maximum power point (MPP) of a power generator, the power control device comprising:
a sensing unit coupled to the power generator for generating a sensed voltage value and a sensed power value according to a cross voltage and an output current of the power generator;
a sample and hold unit coupled to the sensing unit for sampling and holding the sensed voltage value and the sensed power value;
a comparison and determination unit coupled to the sample and hold unit and the sensing unit for generating a determination result according to the sensed voltage value and the sensed power value of a previous time point outputted by the sample and hold unit and the sensed voltage value and the sensed power value of a current time point outputted by the sensing unit; and
a voltage converter coupled to the comparison and determination unit and the power generator for adjusting the cross voltage of the power generator to make the power generator reach to the maximum power point according to the determination result.

2. The power control device of claim 1, wherein the sensing unit comprises:
a voltage sensing circuit coupled to the power generator for sensing the cross voltage to generate the sensed voltage value;
a current sensing circuit coupled to the power generator for sensing the output current to generate a sensed current value; and
a multiplier coupled to the voltage sensing circuit and the current sensing circuit for performing a multiplication operation on the sensed voltage value and sensed current value to generate the sensed power value.

3. The power control device of claim 2, wherein the voltage sensing circuit is a voltage division circuit.

4. The power control device of claim 2, wherein the current sensing circuit comprises:
a sensing resistor coupled in series to the power generator for sensing the output current;
a transconductance amplifier having a positive terminal and a negative terminal, the positive terminal and the negative terminal being coupled to two ends of the sensing resistor respectively, the transconductance amplifier performing a transconductance amplification operation on a voltage difference between the two ends of the sensing resistor to generate a sensed current; and
a current-to-voltage converter coupled to the transconductance amplifier for performing a current-to-voltage conversion operation on the sensed current to generate the sensed current value.

5. The power control device of claim 1, wherein the comparison and determination unit comprises:
a first comparator coupled to the sample and hold unit and the sensing unit for generating a first comparison result according to the sensed voltage value of the previous time point outputted by the sample and hold unit and the sensed voltage value of the current time point outputted by the sensing unit;
a second comparator coupled to the sample and hold unit and the sensing unit for generating a second comparison result according to the sensed power value of the previous time point outputted by the sample and hold unit and the sensed power value of the current time point outputted by the sensing unit; and
a determination unit coupled to the first comparator and the second comparator for generating the determination result according to the first comparison result and the second comparison result.

6. The power control device of claim 1, wherein the comparison and determination unit generates the determination result for raising the cross voltage when the sensed voltage value of the current time point is greater than that of the previous time point and the sensed power value of the current time point is also greater than that of the previous time point.

7. The power control device of claim 1, wherein the comparison and determination unit generates the determination result for decreasing the cross voltage when the sensed voltage value of the current time point is greater than that of the previous time point and the sensed power value of the current time point is smaller than that of the previous time point.

8. The power control device of claim 1, wherein the comparison and determination unit generates the determination result for decreasing the cross voltage when the sensed voltage value of the current time point is smaller than that of the previous time point and the sensed power value of the current time point is greater than that of the previous time point.

9. The power control device of claim 1, wherein the comparison and determination unit generates the determination result for raising the cross voltage when the sensed voltage value of the current time point is smaller than that of the previous time point and the sensed power value of the current time point is also smaller than that of the previous time point.

10. The power control device of claim 1, wherein the voltage converter further performs a direct current to direct current voltage converting operation on the cross voltage to generate a power supply voltage.

11. The power control device of claim 1, wherein the voltage converter adjusts the cross voltage of the power generator via a pulse width modulation (PWM) operation.

12. The power control device of claim 1, wherein the power generator is a photovoltaic panel.

13. The power control device of claim 1, wherein the power generator is a wind power module.

14. A power control method for tracking a maximum power point (MPP) of a power generator, the power control method comprising:
sensing a cross voltage and an output current of the power generator to generate a sensed voltage value and a sensed power value;
sampling and holding the sensed voltage value and the sensed power value;
generating a determination result according to the sensed voltage value and the sensed power value sampled at a previous time point and the sensed voltage value and the sensed power value sensed at a current time point; and
adjusting the cross voltage of the power generator to make the power generator reach to the maximum power point according to the determination result.

15. The power control method of claim 14, wherein sensing the cross voltage and the output current of the power generator comprises steps of:
generating the sensed voltage value according to the cross voltage;
generating a sensed current value according to the output current; and
performing a multiplication operation on the sensed voltage value and sensed current value to generate the sensed power value.

16. The power control method of claim 14, wherein generating the determination result according to the sensed voltage value and the sensed power value sampled at the previous time point and the sensed voltage value and the sensed power value sensed at the current time point comprises steps of:
comparing the sensed voltage value sampled at the previous time point with the sensed voltage value sensed at the current time point to generate a first comparison result;
comparing the sensed power value sampled at the previous time point with the sensed power value sensed at the current time point to generate a second comparison result;
generating the determination result according to the first comparison result and the second comparison result.

17. The power control method of claim 14, wherein generating the determination result according to the sensed voltage value and the sensed power value sampled at the previous time point and the sensed voltage value and the sensed power value sensed at the current time point comprises steps of:
generating the determination result for raising the cross voltage when the sensed voltage value of the current time point is greater than that of the previous time point and the sensed power value of the current time point is also greater than that of the previous time point.

18. The power control method of claim 14, wherein generating the determination result according to the sensed voltage value and the sensed power value sampled at the previous time point and the sensed voltage value and the sensed power value sensed at the current time point comprises steps of:
generating the determination result for decreasing the cross voltage when the sensed voltage value of the current time point is greater than that of the previous time point and the sensed power value of the current time point is smaller than that of the previous time point.

19. The power control method of claim 14, wherein generating the determination result according to the sensed voltage value and the sensed power value sampled at the previous time point and the sensed voltage value and the sensed power value sensed at the current time point comprises steps of:
generating the determination result for decreasing the cross voltage when the sensed voltage value of the current time point is smaller than that of the previous time point and the sensed power value of the current time point is greater than that of the previous time point.

20. The power control method of claim 14, wherein generating the determination result according to the sensed voltage value and the sensed power value sampled at the previous time point and the sensed voltage value and the sensed power value sensed at the current time point comprises steps of:
generating the d determination result for raising the cross voltage when the sensed voltage value of the current time point is smaller than that of the previous time point and the sensed power value of the current time point is also smaller than that of the previous time point.

21. The power control method of claim 14 further comprising:
performing a direct current to direct current voltage converting operation on the cross voltage to generate a power supply voltage.

22. The power control method of claim 14, wherein adjusting the cross voltage of the power generator comprises:
adjusting the cross voltage of the power generator via a pulse width modulation (PWM) operation.

23. The power control method of claim 14, wherein the power generator is a photovoltaic panel.

24. The power control method of claim 14, wherein the power generator is a wind power module.
